(19) United States
(12) Patent Application Publication
(10) Pub. No.: US 2026/0036145 A1
(43) Pub. Date: Feb. 5, 2026

(54) FAN ASSEMBLY AND FAN BLADE DESIGN

(71) Applicant: AirTulip Inc., New York, NY (US)

(72) Inventor: Arjen Teake DE JONG, New York, NY (US)

(73) Assignee: AirTulip Inc., New York, NY (US)

(21) Appl. No.: 19/354,482

(22) Filed: Oct. 9, 2025

Related U.S. Application Data
(63) Continuation of application No. PCT/US2024/023835, filed on Apr. 10, 2024.
(60) Provisional application No. 63/458,487, filed on Apr. 11, 2023.

(51) Int. Cl. F04D 29/66; F04D 17/08; F04D 29/28; F04D 29/42

(52) U.S. Cl. CPC F04D 29/666; F04D 17/08; F04D 29/281; F04D 29/4226

(57) ABSTRACT

A fan assembly has a substantially centrifugal outlet, an axial intake, an airflow channel extending substantially perpendicular to the axial intake, and a guide element for redirecting airflow adjacent the axial intake. The axial intake is spaced apart from a back wall of the airflow channel by a first distance, and the guide element is positioned between the axial intake and the back wall of the airflow channel, or the guide element comprises a back surface of the fan assembly. The airflow from the airflow channel then passes through the guide element to enter the axial intake.

### CROSS-REFERENCE TO RELATED APPLICATION

This application is a continuation of International Application No. PCT/US2024/023835, filed Apr. 10, 2024, which takes priority from U.S. Provisional Patent Application No. 63/458,487 filed Apr. 11, 2023, the contents of each of which are incorporated by reference herein in their entirety.

### FIELD OF THE INVENTION

The invention relates to air movement in a fan assembly for minimal acoustic noise in a compact housing. Also, a means for acoustic and vibration reduction of a flow path using the fan system is provided and discussed.

### BACKGROUND

Various devices may require integration of a fan assembly into furniture incorporated into or located near a bed. Such a fan assembly may be for moving purified air or controlling an airflow adjacent the bed.

Similarly, the fan assembly may be for controlling airflow with some manipulated characteristic. For example, if a user requires air with a modified oxygen content, or if they desire a medicated or scented additive or the like in the airflow, such airflow is typically generated near the user's bed.

When a fan assembly is located near or integrated into a user's bed, acoustic noise and vibration may disturb the user's sleep. As such, there is a need to minimize such noise and vibration.

### SUMMARY

The system may compromise 3 components, a stator, a rotor, and a shroud.

Physics: Acoustic noise is typically generated mostly on the leading edge and trailing edge, where turbulence is converted into dipole-like sound emissions. On the middle sections attached flow of the rest of the blade, the boundary layer noise is quadrupole-like and less sound is produced. Embodiments described herein adjust typical fan designs to minimize noise generated by the leading and trailing edges.

On the leading edges, upstream turbulence impinges on the leading edge giving a low frequency contribution. Also, the blade velocity in the rotating frame of motion provides an increased air velocity impinging on the blades. As acoustic noise scales strongly with air velocity (typically to the power of 5 to 6 for the specific conditions described here), minimizing the air velocity and the upstream turbulence is beneficial in the reduction of leading edge noise. In embodiments described herein, a static flow device is designed that 1 provides an even flow distribution, 2 removes large scale turbulence and 3 creates a pre-swirl. The pre-swirl is typically non-constant and stronger at the shroud location vs the hub location to match to a certain extend the local blade velocity upon the flow reaching it. This means that the shroud induced swirl may be higher than the hub one.

An embodiment of this stator consists of cascading airfoil-like sections, with sizes decreasing as the flow enters the device. This minimizes self-noise and eliminates different scales of turbulence in steps.

Another embodiment has a guide element, or shroud, with channels with a length to width ratio of greater than about 4, preventing turbulent eddies of a certain size to pass by blocking the cross-flow component of the eddies.

For 3d-printability, in some embodiments, the channels are diamond-shaped. This prevents unsupported flat roofs on a typical build plate. The system is also designed in multiple distinct pieces to aid the additive manufacturing production process.

The curvature of the flow guides and blade locations: in a highly curved flow, a local high velocity section can be present near the wall. In order to minimize acoustic noise, the curvature of the channel is distributed to have less curvature and thus flow velocity where blades start.

Splitter blades are incorporated in the channel, starting later along the meridional flow path than the main blades. Again, changes in channel curvature are taken into account to minimize flow velocity.

The motor mounting and location: plug fan motor mounts are typically mount from the back part. This means that any static shroud needs to be supported using a long distance between motor mounting point and shroud mounting point. Some embodiments negate this by mounting the fan motor in reverse, directly holding both stator and rotor portions.

A gap between the stator and rotor is smaller than usual fans due to the motor positioning. The slot is also designed to create an attached flow over the curved surface.

The trailing edge may have serrations, which limit trailing edge broadband noise.

The hub and shroud may also have serrations, the direction of the serrations may match the local flow speed.

The blades may be provided with uneven spacing to minimize tonal noise

The trailing edges may have a non-perpendicular angle with respect to the hub and shroud to even out pressure pulses.

The inlet and exhausts may be mounted in a dampening material system.

The inlet section may have curved channels to minimize line-of-sight and may have a minimum open cross-sectional area to ensure an average flow speed below around 5 m/s.

The outlet may incorporate a double exhaust guide for converting any rotational flow from the fan into useful pressure.

The mounting of the system may be a novel box-in-box design: instead of mounting points, the whole fan assembly may be supported by acoustic dampening materials over a large section in all directions. A top lid may then enclose the inner box.

A fan assembly typically comprises a substantially centrifugal outlet, an axial intake, an airflow channel extending substantially perpendicular to the axial intake, and a guide element for redirecting airflow adjacent the axial intake. The axial intake is spaced apart from a back wall of the airflow channel by a first distance, and the guide element is positioned between the axial intake and the back wall of the airflow channel, or the guide element comprises a back surface of the fan assembly. The airflow from the airflow channel then passes through the guide element to enter the axial intake.

In some embodiments, the guide element directs airflow towards the axial intake circumferentially relative to an axis of the axial intake in a direction of rotation of blades of the fan assembly.

In some such embodiments, the guide element is a substantially cylindrical perforated shroud centered on the axis of the axial intake and the shroud comprises channels running substantially radially from the axial intake. The radially inner ends of the channels are then angled or bent in the direction of rotation of the blades relative to the radial direction.

In some such embodiments, the axial intake and the centrifugal outlet comprise a fan unit. The fan unit further includes the blades of the fan assembly, and at least some of the channels are sloped towards the fan unit at the radially inner ends of the channels.

In some embodiments in which the radially inner ends of the channels are angled or bent, the axial intake and the centrifugal outlet comprise a fan unit. The fan unit further includes the blades of the fan assembly, and a first plurality of channels of the shroud are located at a first axial location along a thickness of the cylindrical shroud and a second plurality of channels of the shroud are located at a second axial location along the thickness of the cylindrical shroud closer to the fan unit than the first axial location. The second plurality of channels then deviates from the radial direction by more than the first plurality of channels.

In some embodiments in which the radially inner ends of the channels are angled or bent, each of the channels is smaller at the radially inner end than at a corresponding radially outer end.

In some embodiments in which the radially inner ends of the channels are angled or bent, each of the channels are substantially diamond shaped.

In some embodiments in which the radially inner ends of the channels are angled or bent, each of the channels has a length to width ratio greater than approximately 4.

In some embodiments the fan assembly has a plurality of fan blades, and wherein each fan blade extends from a radially outer end adjacent the guide element to a radially inner end adjacent a hub and is sloped relative to the axial direction of the axial intake.

In some such embodiments, for each fan blade, a slope at the radially outer end is steeper than a slope at the radially inner end.

In some embodiments, airflow paths are formed between adjacent fan blades extending from the axial intake to the centrifugal outlet, and each fan blade has a width that increases as it extends away from the axial intake, such that the airflow paths are narrowed following the axial intake. In some such embodiments, each fan blade has an airfoil-like cross-section.

In some embodiments, primary airflow paths are formed between adjacent fan blades extending from the axial intake to the centrifugal outlet. The fan assembly may then further include at least one secondary splitter blade located within each of the primary airflow paths, and the secondary splitter blade then further divides the corresponding primary airflow path into secondary airflow paths as the primary airflow path approaches the substantially centrifugal outlet.

In some such embodiments, each of the fan blades and the secondary splitter blades have an airfoil-like cross-section.

In some embodiments having secondary splitter blades, the secondary airflow paths are smaller than the primary airflow paths, and, during use, turbulent eddies are damped sequentially, thereby reducing leading edge blade impingement.

In some embodiments having secondary splitter blades a plurality of primary airflow paths are formed between adjacent fan blades extending from the axial intake to the centrifugal outlet, and each primary airflow path divides into a plurality of secondary airflow paths. A first primary airflow path of the plurality of primary airflow paths and the plurality of secondary airflow paths contained therein then differ from a second primary airflow path of the plurality of primary airflow paths and the plurality of secondary airflow paths contained therein in size or geometry.

In some such embodiments, for a sequence of four pairs of fan blades and adjacent secondary splitter blades, the blade combinations are offset from a rotationally symmetrical configuration by 3 degrees for a first pair of the four pairs, by 0 degrees for a second pair of the four pairs, by 1 degree for a third par of the four pairs, and by 0 degrees for a fourth pair of the four pairs.

In some embodiments having secondary splitter blades, each fan blade twists from the corresponding radially inner end to the corresponding radially outer end, and each fan blade terminates in a reverse twist, such that a radially outermost cross-section of the fan blade is steeper than at least one radial cross-section of the fan blade between the radially outer end and the radially inner end.

In some embodiments having secondary splitter blades, each fan blade terminates in a plurality of serrations along a circumferentially outer end.

In some such embodiments, the fan blades are integrated into a fan blade base component, such that the fan blade base component rotates with the fan blades, and a circumferentially outer edge of the fan blade base component terminates in a plurality of serrations.

In some embodiments utilizing serrations, the serrations are angled with respect to a mean flow line established by the fan blades. In some such embodiments, the serrations are swept back, such that they interfere with airflow generated by an adjacent fan blade.

In some embodiments having secondary splitter blades, wherein a plurality of airflow paths are formed between adjacent fan blades extending from the axial intake to the centrifugal outlet, and wherein a first airflow path of the plurality of airflow paths between a first pair of adjacent fan blades differs from a second airflow path of the plurality of airflow paths between a second pair of adjacent fan blades in size or geometry.

In some embodiments, the axial intake and the centrifugal outlet comprise a fan unit, the fan unit further comprising a plurality of blades of the fan assembly, and the guide element is mounted on a stator, and the plurality of blades are mounted on a rotor for the fan unit.

In some such embodiments, the fan assembly includes a motor located adjacent the axial intake.

In some such embodiments, the guide element is substantially cylindrical and extends along an axis of the axial intake, and the motor is located at least partially within the circumference of the guide element.

In some such embodiments, the guide element comprises a mounting structure for the motor, and the mounting structure reduces a size of an internal chamber within the guide element adjacent the axial intake.

In some embodiments having a substantially cylindrical guide element, the motor at least partially defines a gap between the rotor and stator of the fan assembly.

In some such embodiments, the fan assembly is supported by the motor or the stator.

In some embodiments, the axial intake and the centrifugal outlet comprise a fan unit, the fan unit further comprising a plurality of blades of the fan assembly. The plurality of blades are located circumferentially about the axial intake, and the spacing between adjacent blades of the plurality of blades is varied.

In some embodiments, the axial intake and the centrifugal outlet comprise a fan unit, the fan unit further comprising a plurality of blades of the fan assembly, and the fan assembly further includes an inner housing enclosing the fan unit, and the guide element extends through a wall of the inner housing to an outer housing comprising the airflow channel.

In some embodiments, the centrifugal outlet comprises at least one exhaust guide for converting rotational flow at the centrifugal outlet into pressure.

### BRIEF DESCRIPTION OF THE DRAWINGS

FIG. 1 is a side view of a fan assembly in accordance with this disclosure.

FIG. 2 is a front perspective view of the fan assembly of FIG. 1.

FIG. 3 is a rear perspective view of the fan assembly of FIG. 1.

FIG. 4 is an exploded view of the fan assembly of FIG. 1.

FIG. 5 is a front elevation view of a part of a rotor for use in the fan assembly of FIG. 1.

FIG. 6 is a perspective view of the part of the rotor of FIG. 5.

FIG. 7 is a side view of a rotor containing the part of FIG. 5.

FIG. 8 is a perspective view of the rotor of FIG. 7.

FIG. 9 is an illustration of flow-induced noises associated with a lifting surface, such as a fan blade.

FIGS. 10A and 10B illustrate relative velocity at different locations within the fan assembly of FIG. 1.

FIG. 11 is a section view of the fan assembly of FIG. 1.

FIG. 12 is a meridional view of airflow through the fan assembly of FIG. 1.

FIG. 13 illustrates an excessive speed differential in a variation of the proposed fan assembly.

FIG. 14 illustrates the corresponding speed differential in the fan assembly of FIG. 1.

FIG. 15 illustrates fan blade profiles in the context of the fan assembly of FIG. 1.

FIG. 16 illustrates a sectioned perspective view of a shroud for use in the fan assembly of FIG. 1.

FIG. 17 illustrates a schematic cross-section associated with the shroud of FIG. 16.

FIG. 18 is a cross-section of the shroud of FIG. 16 at a first height.

FIG. 19 is a cross-section of the shroud of FIG. 16 at a second height.

FIG. 20 is a schematic illustration of airflow through the shroud of FIG. 16.

FIGS. 21A-B illustrate schematic illustrations of airflow through the shroud at the first and second heights.

FIG. 22 is an elevation cross-section of the shroud of FIG. 16.

FIG. 23A is an elevation cross-section of the part of FIG. 5.

FIG. 23B is a detail view of a portion of the cross-section of FIG. 23A.

FIGS. 24A-B are cross-sectional views of the part of FIG. 5 taken at different locations along a fan blade.

FIG. 25 is a housing for containing the fan assembly of FIG. 1.

FIGS. 26A-B are different views of a housing for containing the fan assembly of FIG. 1.

FIGS. 27A-B are front elevation views of an alternate embodiment of the part of the rotor of FIG. 5.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

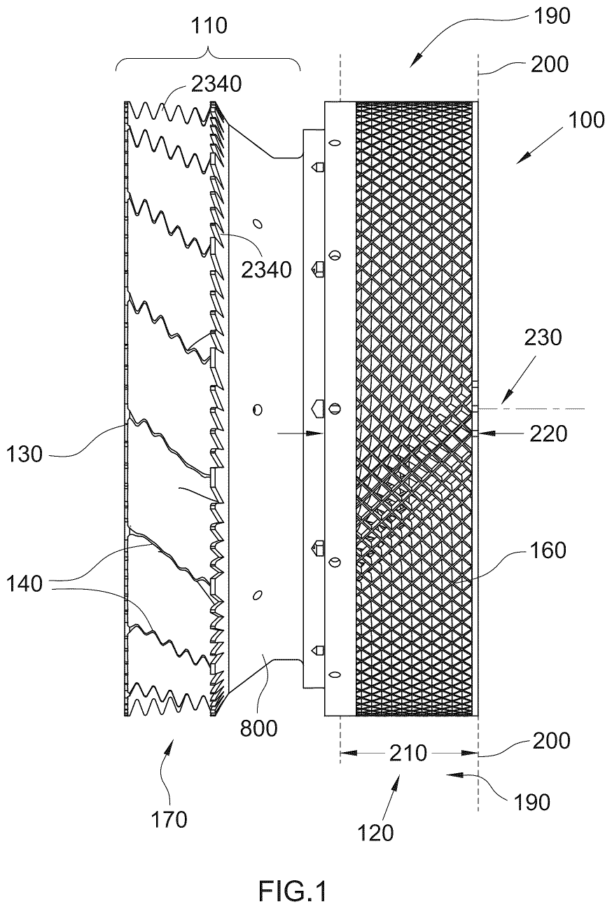

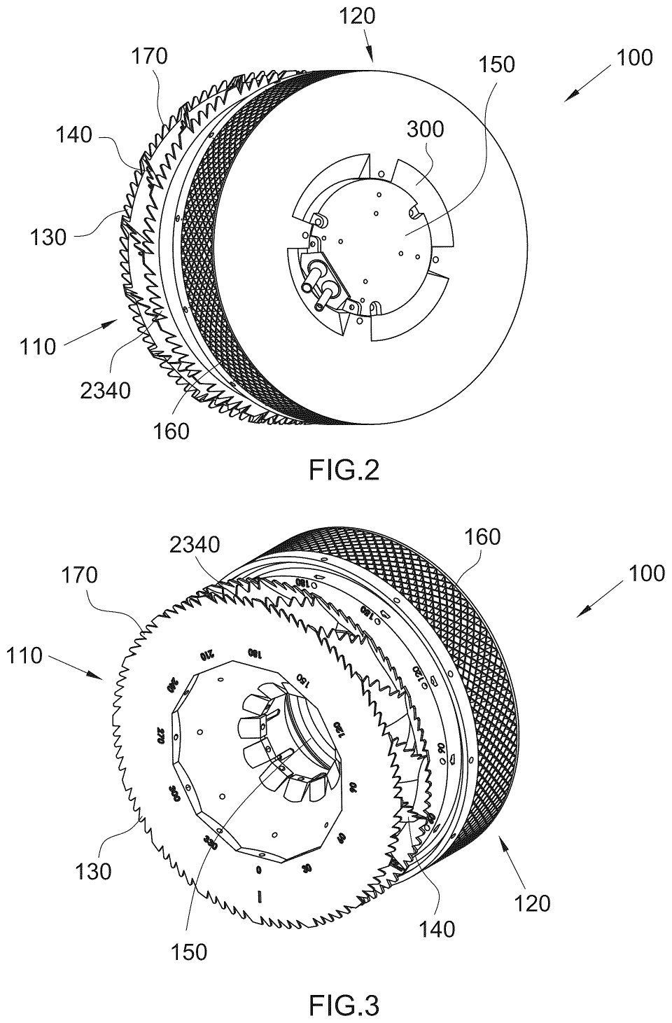

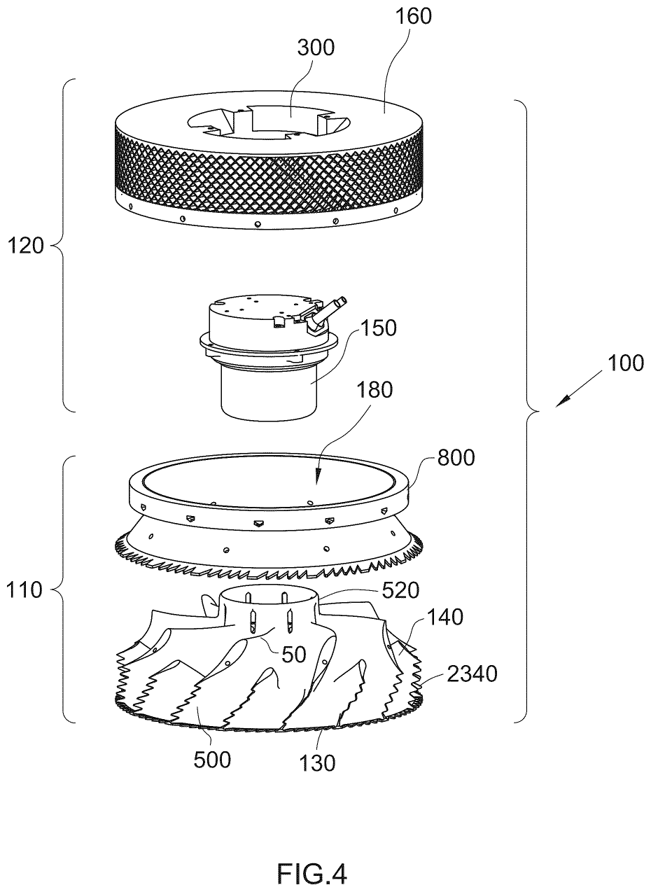

FIG. 1 is a side view of a fan assembly 100 in accordance with this disclosure. FIG. 2 is a front perspective view of the fan assembly 100 of FIG. 1. FIG. 3 is a rear perspective view of the fan assembly 100 of FIG. 1. FIG. 4 is an exploded view of the fan assembly 100 of FIG. 1.

As shown, the fan assembly 100 may include a rotor assembly 110 and a stator assembly 120. The rotor assembly 110 may include a base component 130 that comprises a plurality of fan blades 140. The stator assembly 120 may include a motor 150 and a guide element 160.

The fan assembly 100, when fully assembled, may then provide a substantially centrifugal outlet 170, which may be defined by the rotor assembly 110, and an axial intake 180, also defined by the rotor assembly. The fan assembly 100 may then include, or be located within, an airflow channel 190 extending substantially perpendicular to the axial intake 180. The guide element 160 may then be located within the airflow channel 190 and may redirect airflow in the airflow channel adjacent the axial intake 180.

In some embodiments, the combination of the fan blades 140, the centrifugal outlet 170, and the axial intake 180 are referred to as the fan unit 110 of the fan assembly 100. In the embodiments shown, the fan unit 110 corresponds to the rotor assembly 110. However, in some embodiments, the axial intake 180, for example, may be distinct from and independent of the rotor 110.

The axial intake 180 may then be spaced apart from a back wall 200 of the airflow channel 190 by a first distance 210 and the guide element is positioned between the axial intake 180 and the back wall 200 of the airflow channel 190. In some embodiments, the guide element has a thickness 220 substantially corresponding to the first distance 210, such that the guide element largely fills the space between the axial intake 180 and the back wall 200. In some embodiments, the guide element 160 further comprises a back surface of the fan assembly 100 or is integrated into the back wall 200. Accordingly, the airflow from the airflow channel 190 pass through the guide element 160 in order to enter the axial intake 180.

During use, the rotor 110 rotates relative to the stator 120 about an axis 230. The rotor 110 moves airflow received from the guide element 160 and generates suction such that additional airflow flows through the guide element. Once through the guide element 160, the airflow enters the rotor 110 in the direction of the axis 230, with this movement in the direction of the axis being at the axial intake 180. Accordingly, the guide element 160 transports airflow laterally before the airflow turns in the direction of the axis 230. The axial intake 180 is more clearly visible in FIG. 8.

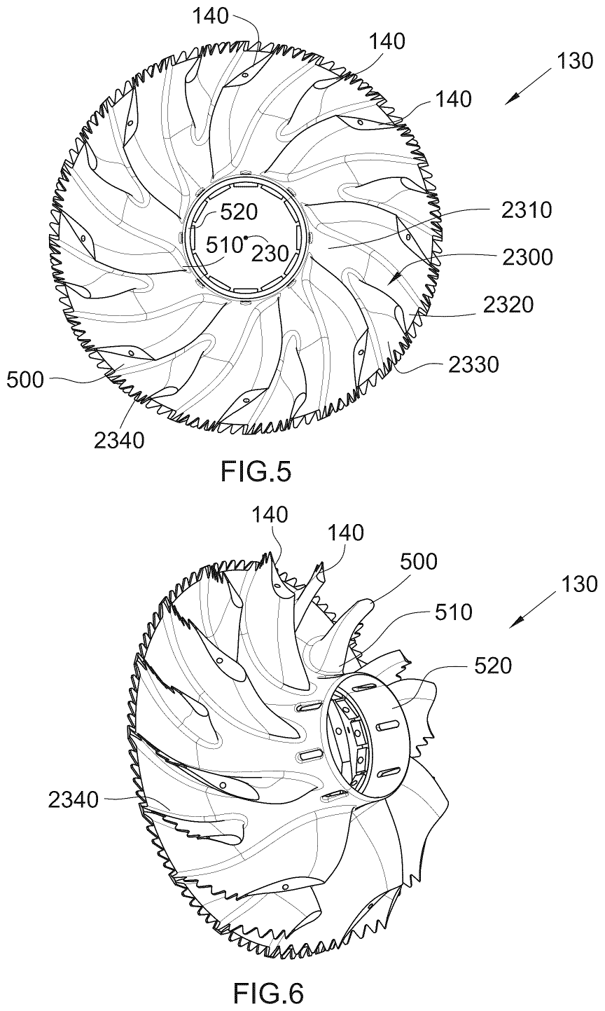

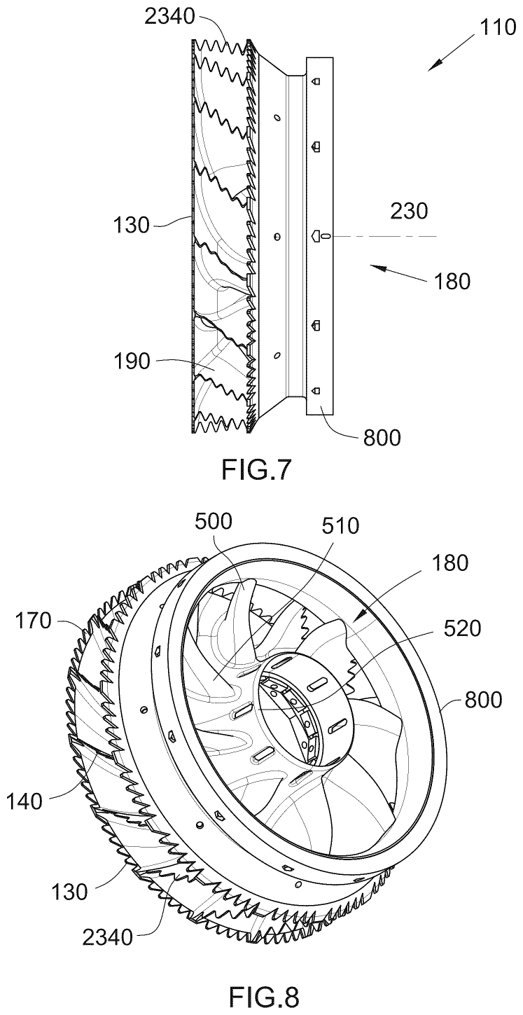

FIG. 5 is a front elevation view of a part of a rotor 110 for use in the fan assembly of FIG. 1, namely a base component 130 of the rotor 110. FIG. 6 is a perspective view of the base component 130 of the rotor 110 of FIG. 5. FIG. 7 is a side view of a rotor 110 containing the base component 130 of FIG. 5. FIG. 8 is a perspective view of the rotor 110 of FIG. 7. As shown, the rotor 110 includes the base component 130 combined with a cap 800 for completing the rotor.

As shown, the fan assembly 100 includes a plurality of fan blades 140. Each of the fan blades 140 then extends from a radially outer end 500 adjacent the guide element 160 to a radially inner end 510 adjacent a hub 520 of the fan assembly 100. The hub 520 of the fan assembly 100 may be integrated into the base component 130.

During use, as noted above, the rotor 110 rotates relative to the stator 120, and as such, the fan blades 140 sweep past any given point of the guide element 160. Any airflow passing through the guide element 160 is then swept up by the passing fan blades 140, simultaneously moving the airflow in the direction of the axial intake 180 and generating suction for drawing additional airflow through the guide element.

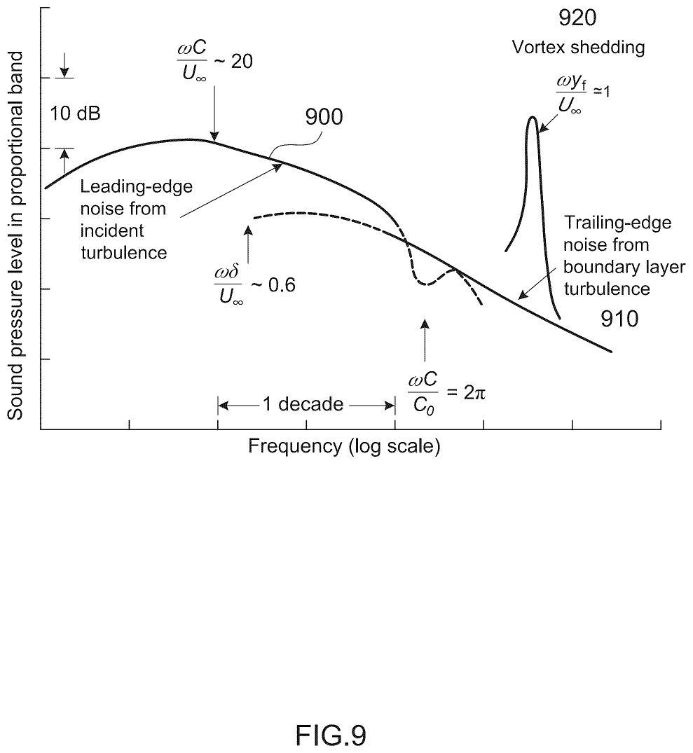

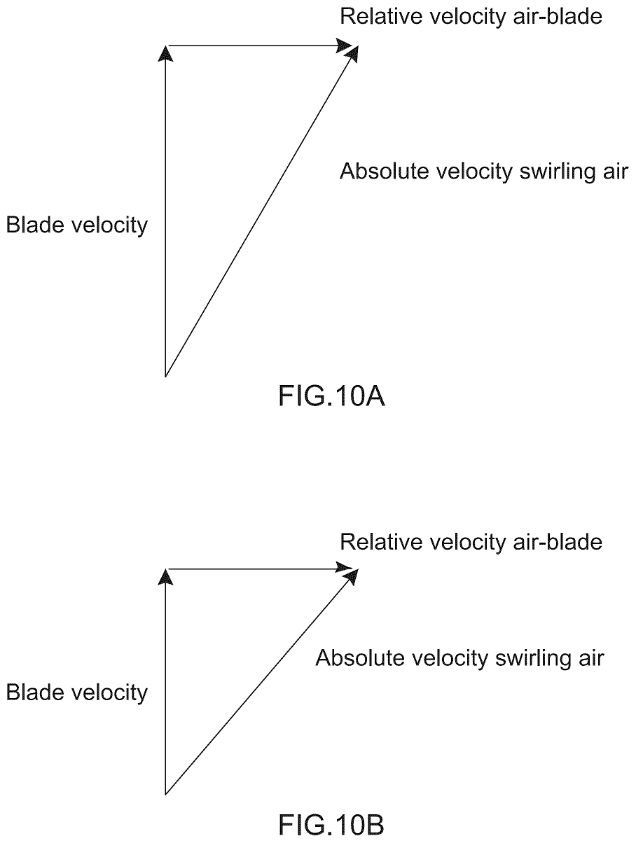

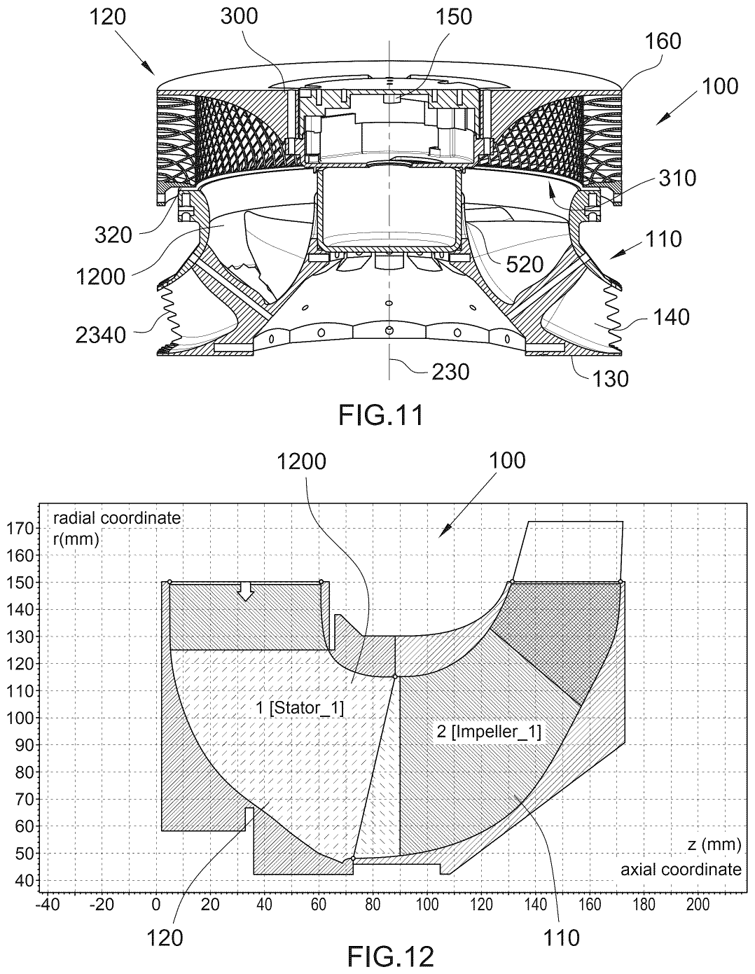

FIG. 9 is an illustration of flow-induced noises associated with a lifting surface, such as a fan blade 140. As shown, there are three primary sources of noise in the context of a fan. Initially, noise is generated from incident turbulence at a leading edge of a fan blade 900 generated when the fan blade impacts air being drawn into the fan. This initial noise may be reduced or manipulated by reducing a relative velocity in the airflow, as discussed below with respect to FIGS. 10 and 11. This is further discussed below in the context of the blade 140 geometry and the guide element 160. Later, noise is generated from the trailing edge separating from the air flow 910 generating local turbulence. This is discussed below in the context of serrations 2340 at the trailing edge of the blades 140 as well as the blade geometry. Separately, noise can be generated by vortex shedding 920, which may generate an oscillating sound at certain velocities. This is discussed in the context of blade 140 geometry and spacing as well as the creation of primary and secondary airflow channels 2310, 2320. As is apparent from the table provided, all of these noises are sensitive to frequency of the rotations of the rotor 110. However, the noises generated are also sensitive to the shape of various components of the fan blades. Further, while the noises are sensitive to frequency of the rotor 110, the noises are largely generated by a velocity of airflow relative to a fan blade, and as such, the airflow itself can be manipulated to reduce such noise.

FIGS. 10A and 10B illustrate relative velocity at different locations within the fan assembly 100 of FIG. 1. In particular, FIG. 10A shows the relative velocity of airflow to blade velocity directly adjacent the guide element 160, at the radially outer end 500 of a given fan blade 140. FIG. 10B then shows the relative velocity of airflow to blade velocity at the radially inner end 510 of the fan blade 140 adjacent the hub 520. During rotation, a radially outer end 500 of a fan blade 140 necessarily moves faster than a radially inner end 510. However, as shown, if the absolute velocity of the airflow can be manipulated such that it is faster at a radially outer position within the stator, the relative velocity can be kept constant at both ends of each fan blade 140.

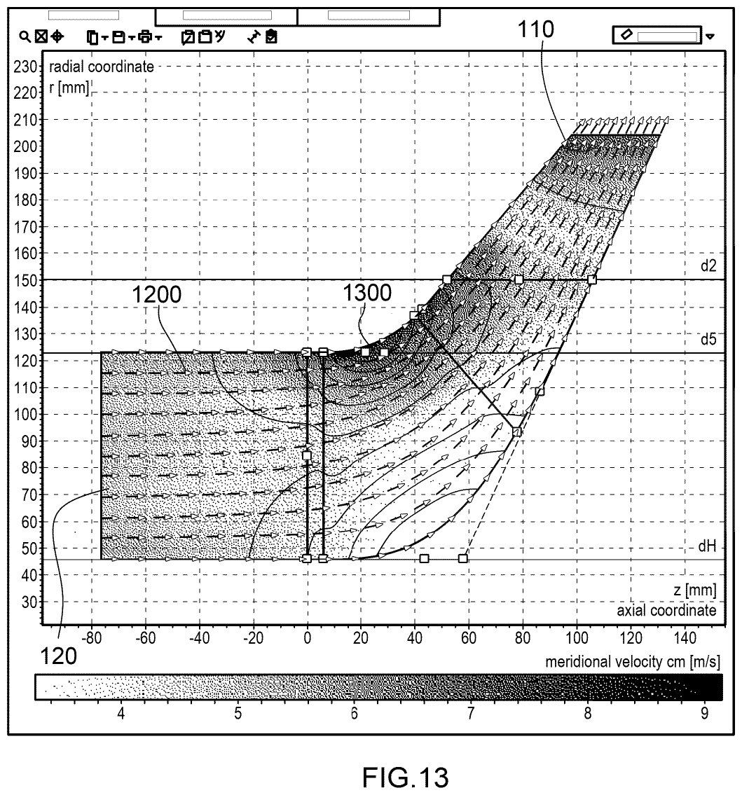

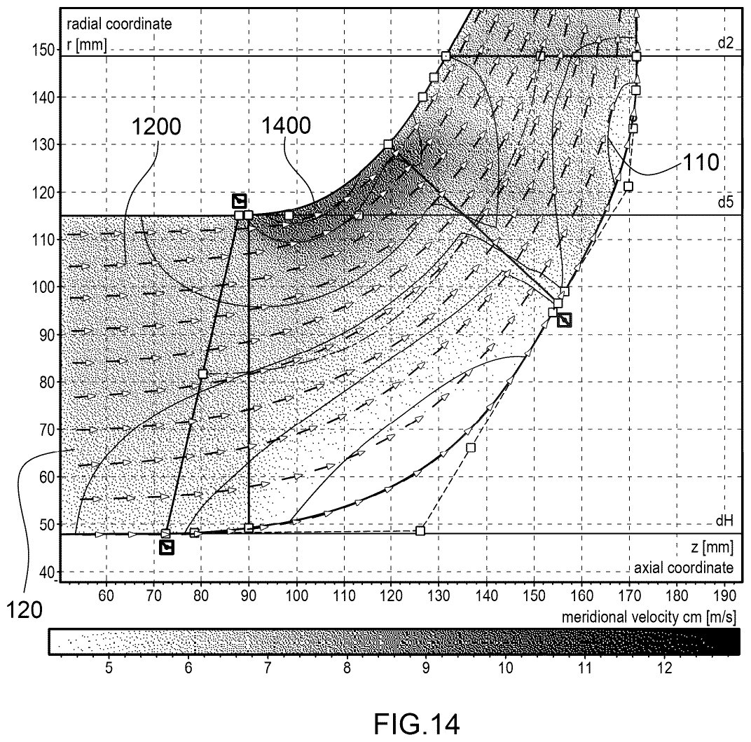

FIG. 11 is a section view of the fan assembly 100 of FIG. 1. FIG. 12 is a meridional view of airflow through the fan assembly 100 of FIG. 1. Such a view may be used to observe pressures and relative velocities at both the radially inner end 510 and the radially outer end 500 of the fan blade at various locations along a fluid path 1200 followed by the airflow. FIG. 13 illustrates an excessive speed differential 1300 in a variation of the proposed fan assembly with a different geometry. FIG. 14 illustrates the corresponding speed differential in the fan assembly of FIG. 1. By adjusting the geometry appropriately, as shown in FIG. 14, the maximum speed differential 1400 can be reduced to within acceptable limits, thereby reducing sound generated at the corresponding location.

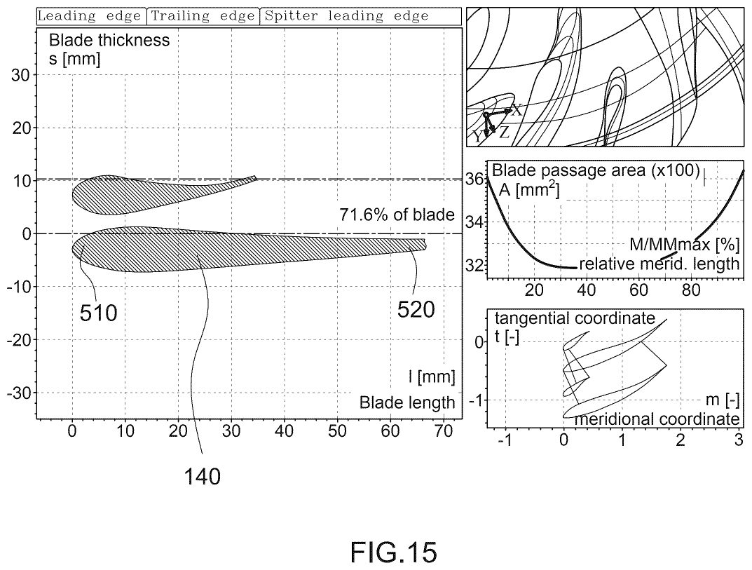

FIG. 15 illustrates fan blade 140 profiles in the context of the fan assembly of FIG. 1. As shown, and as discussed in more detail below, the fan blades 14 may each be provided with an airfoil-like cross-section.

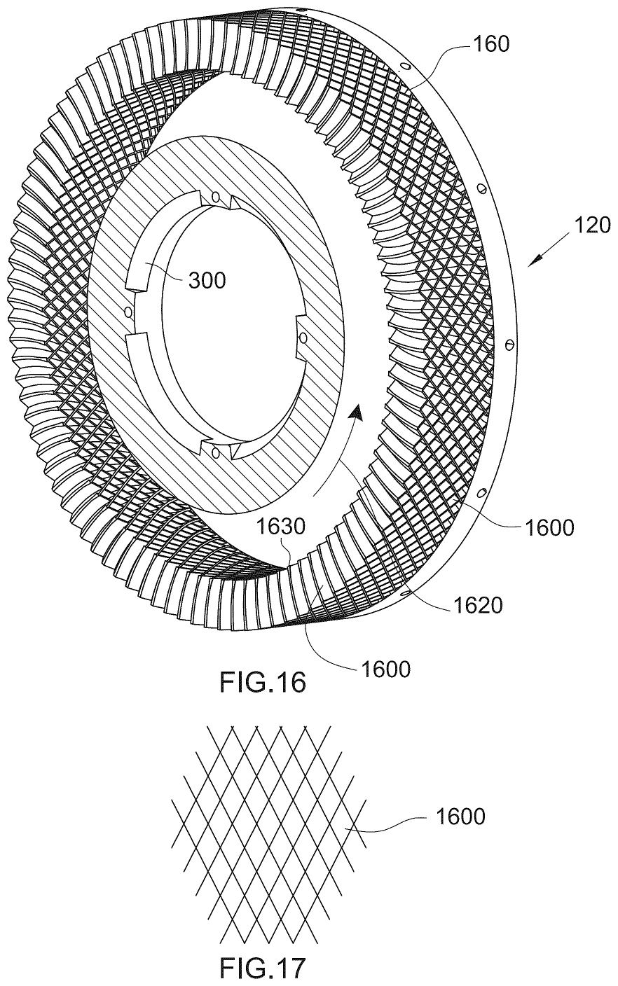

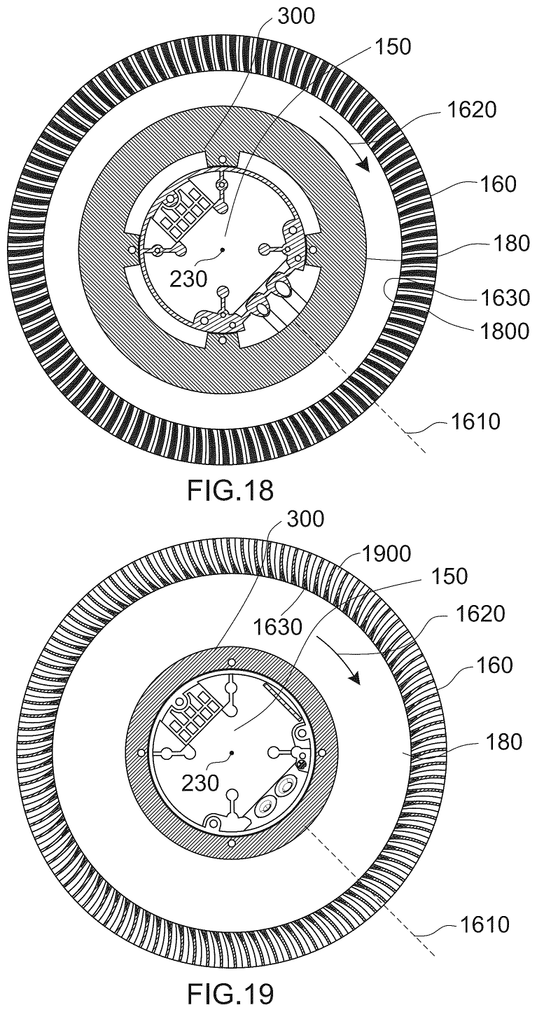

FIG. 16 illustrates a sectioned perspective view of a shroud for use as the guide element 160 in the fan assembly 100 of FIG. 1. FIG. 17 illustrates a schematic cross-section associated with the shroud 160 of FIG. 16. FIG. 18 is a cross-section of the shroud 160 of FIG. 16 at a first height. FIG. 19 is a cross-section of the shroud 160 of FIG. 16 at a second height.

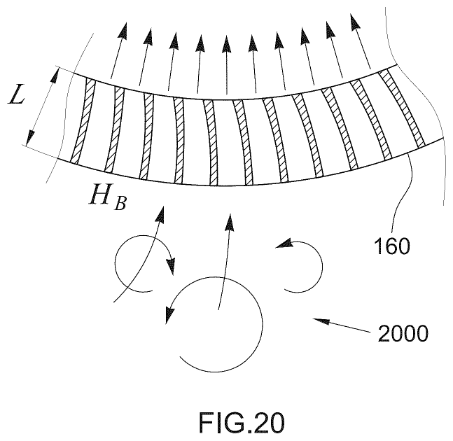

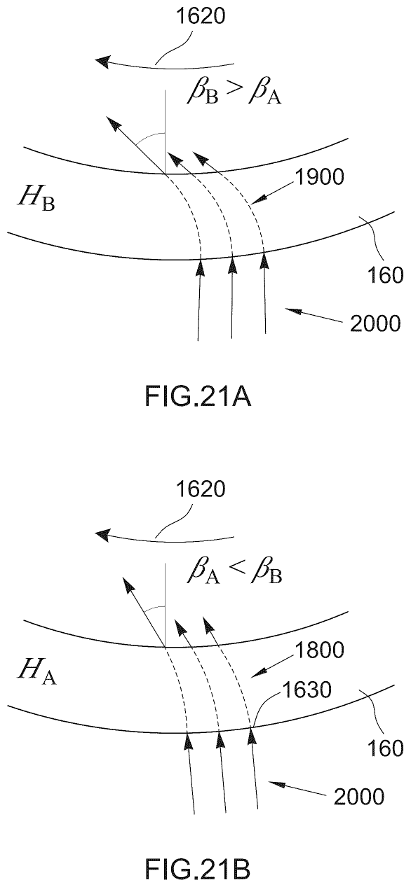

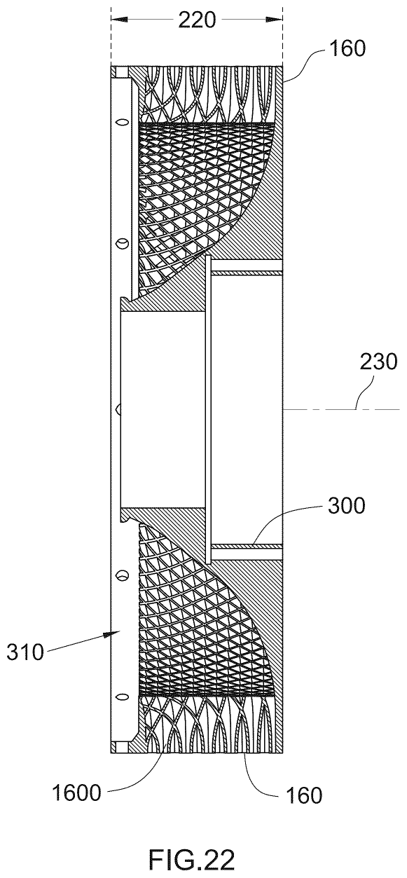

FIG. 20 is a schematic illustration of airflow 2000 through the shroud 160 of FIG. 16. FIGS. 21A-B illustrate schematic illustrations of airflow 2000 through the shroud 160 at the first and second heights HA and HB. FIG. 22 is an elevation cross-section of the shroud 160 of FIG. 16.

As shown, the guide element, or shroud 160, is a substantially cylindrical shroud, and it is perforated with openings 1600 for allowing airflow 2000 to pass through. The perforations 1600 are generally channels running substantially in a radial direction 1610 from the axis 230 of the axial intake 180.

Within the axial intake 180, the blades 140 of the rotor 110 rotate in a circumferential direction 1620 about the axis 230. While the channels 1600 run substantially radially from the axial intake 180, the radial inner ends 1630 of the channels 1600 are angled or bent in the direction of rotation 1620 of the blades 140 of the fan assembly 100 relative to the radial direction 1610.

Further, as shown in FIG. 1, the fan unit 110, or rotor, includes the axial intake 180 and the centrifugal outlet 170 along with the blades 140 of the fan assembly 100. The stator 120 unit, including the guide element or shroud 160 is then mounted adjacent the axial intake 180 and extends away from the intake axially. Accordingly, as shown in FIG. 22, in some embodiments, at least some of the channels 1600 may be sloped towards the fan unit 110 at the radially inner ends 1630 of the channels.

As noted above, the shroud 160 has a thickness 220, and characteristics of the channels 1600 may be different at different heights HA and HB along the thickness. Accordingly, in some embodiments, as shown in FIGS. 18 and 19, a first plurality of channels 1800 may be located at a first axial location along the thickness 220 of the cylindrical shroud 160. A second plurality of channels 1900 may then be located at a second axial location along the thickness 220 of the cylindrical shroud 160 closer to the fan.

As shown, the channels 1600 at the different heights may deviate from the radial direction 1610 by different amounts, and the plurality of channels 1900 at the second height HB closer to the fan may deviate from the radial direction by more than the plurality of channels 1800 at the first height HA farther from the fan. In the drawings, the deviation from the radial direction is shown by the angles β_{A} and β_{B} for the first height HA and the second height HB respectively. Accordingly, the deviation at the second height BB is larger than the deviation at the first height BA.

Because of the nature of a radially extending fan blade 140, as shown, a portion of the fan blade 140 at a radially outer end 500 of a given blade will move faster than a portion of the fan blade at a radially inner end 510. Accordingly, the portion of the blade 140 adjacent the shroud 160 is moving faster than the portion of the blade 140 adjacent the hub 520. Accordingly, as shown in FIGS. 10A and 10B, in order to reduce the relative velocity of airflow to blade velocity throughout the fan unit 110, the shroud 160 is used to generate a pre-swirl so that the airflow in the system is initially moving in the same circumferential direction of the fan blades 140. This is done by providing the channels 1600 with a deviation from the radial direction 1610.

Further, in order to maintain a similar relative velocity at both the radially inner end 510 and the radially outer end 500 of the fan blades 140, the pre-swirl associated with airflow expected to impact the fan blades 140 at different radial locations may be provided with different degrees of pre-swirl. Accordingly, the channels 1900 at the second height HB, being radially closer to the axial intake 180, would be expected to impact the fan blades 140 sooner, and therefore at the radially outer end 500, and are therefore provided with a more extreme deviation BB from the radial direction 1610. Similarly, the channels 1800 at the first height HA, being radially further from the axial intake 180, would be expected to travel radially further before being drawn towards the fan unit 110 by the axial intake 180, and would therefore be expected to impact the fan blades 140 at a radially inner end 510. As such, the pre-swirl applied to airflow at the second height may be less, and the deviation BB from the radial direction 1610 would therefore be less extreme.

The path followed by airflow at different locations within the airflow path is apparent in the drawings showing sectioned and meridional views of the assembly in FIGS. 11-14. The manipulation of the circumferential speed of airflow by the shroud 160 may then be used to avoid excessive speed differentials 1300, as shown by the reduced maximum speed differential 1400 of FIG. 14.

In the embodiment of the shroud 160 shown, each channel 1600, 1800, 1900 may narrow at its radially inner end 1630 relative to its radially outer end 1640, and as such each channel may therefore be smaller at its radially inner end.

As shown in FIG. 17, the channels 1600, 1800, 1900 may be provided with a substantially diamond shaped profile. Such a profile may provide additional stability and may ease manufacturing, such as by easing additive processes. Further, in the embodiments shown, each channel 1600, 1800, 1900 may have a length to width ratio greater than approximately 3, with the length of the passage substantially corresponding to a thickness of the shroud and shown as L in some figures. In some embodiments, the length to width ratio is greater than approximately 4. It is understood that while a substantially diamond shaped profile is shown, other profile shapes are contemplated as well, such as hexagonal channels or the like.

In some embodiments, at least one wall of a channel 1600, 1800, 1900 has a thickened profile selected for airflow properties, such as an airfoil shape.

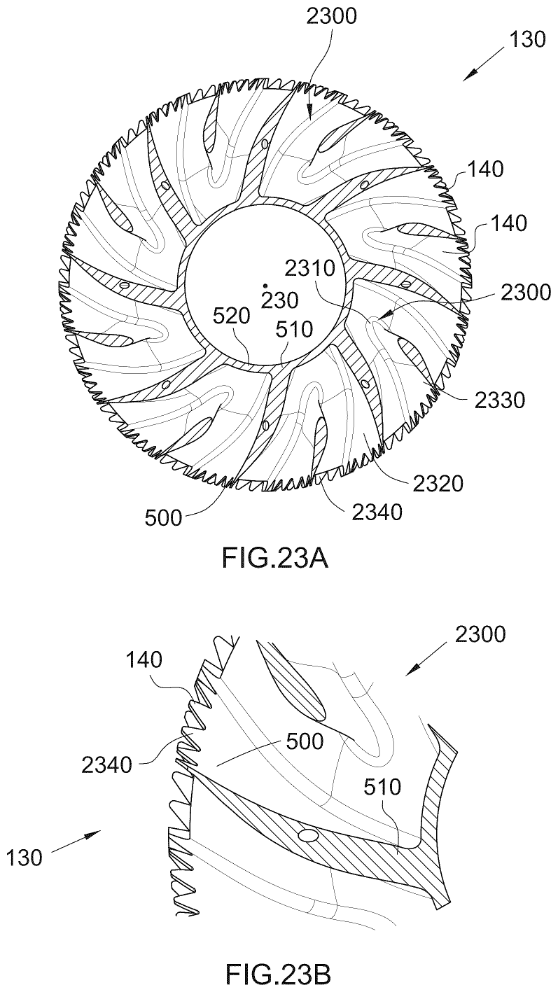

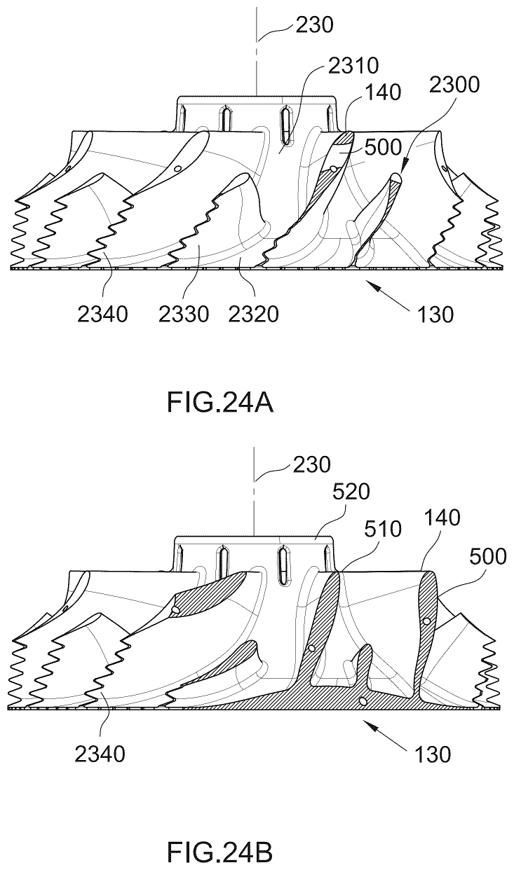

FIG. 23A is an elevation cross-sections of the base component 130 of the rotor 110 of FIG. 5. FIG. 23B is a detail view of a portion of the cross-section of FIG. 23A. FIGS. 24A-B are cross-sectional views of the base component 130 of the rotor 110 of FIG. 5 taken at different locations along a fan blade. FIG. 24A is therefore a cross-section taken at the radially outer end 500 of the fan blade 140 adjacent the shroud 160 or the centrifugal outlet 170, while FIG. 24B is taken at a radially inner end 510 of the fan blade 140 adjacent the hub 520.

As shown, the fan assembly 100 comprises a plurality of fan blades 140. Each fan blade 140 extends from a radially outer end 500 adjacent the guide element 160, or shroud, to a radially inner end 510 adjacent the hub 520. As shown, each blade 140 is sloped relative to the axial direction of the axial intake 180. In some embodiments, as shown, a slope at the radially outer end 500 is steeper than a slope at the radially inner end 510 of the fan blade 140.

The plurality of fan blades 140 combine to define airflow paths 2300 formed between adjacent fan blades. Such airflow paths 2300 then extend from the axial intake 180 to the centrifugal outlet 170.

Each fan blade may then have a width that increases as it extends away from the axial intake 180 following a narrower leading edge. Such an increasing width is not apparent in the sections shown in FIGS. 23A-B, since the airflow paths 2300 are in three dimensions. However, such sections are more apparent in FIGS. 24A-B. Accordingly, the airflow paths 2300 may be narrowed following the axial intake 180. As shown, and as is shown more clearly in FIG. 15, each fan blade 140 may be provided with an airfoil-like cross-section.

In some embodiments, the airflow paths 2300 may comprise primary airflow paths 2310 and secondary airflow paths 2320. As shown in FIG. 23A, primary airflow paths 2310 may be formed between adjacent fan blades extending from the axial intake 180 to the centrifugal outlet. The fan assembly 100 may then further include secondary splitter blades 2330 located within the primary airflow paths 2310. The secondary splitter blades 2330 may then further divide the corresponding primary airflow paths 2310 into secondary airflow paths 2320 as the primary airflow paths approach the substantially centrifugal outlet 170.

As can be seen in FIGS. 24A and 24B as well as in FIG. 15, each of the fan blades 140 and the secondary splitter blades 2330 may have an airfoil-like cross-section.

The approach of providing primary and secondary airflow paths 2310, 2320 allows for the path to narrow sequentially, or at least prevent the paths from enlarging. The secondary airflow paths 2320 are then smaller than the primary airflow paths 2310, and during use, turbulent eddies are damped sequentially, thereby reducing leading edge blade impingement, which could otherwise lead to excessive noise.

In some embodiments, as shown, each fan blade 140 twists from the corresponding radially inner end 510 to the corresponding radially outer end 500. In some such embodiments, each fan blade terminates in a reverse twist, such that a radially outermost cross-section of the fan blade 140, typically at the trailing edge, is steeper than at least one radial cross-section of the fan blade between the radially outer end 500 and the radially inner end 510.

Further, each blade 140 typically curves, or bends, from the inner end 510 to the outer end 500. This may improve airflow characteristics, and it may also be optimized to prevent line-of-sight between the axial intake 180 and the centrifugal outlet 170.

In some embodiments, the trailing edge of the fan blades 140 are explicitly designed not to be perpendicular with respect to the shroud 160, and not to be parallel with the axis of rotation 230. In this way, acoustic pressure pulses may be more evenly distributed throughout a rotation of the rotor 110.

In some embodiments, such as those shown, each fan blade 140 terminates in a plurality of serrations 2340 arranged along a circumferentially outer end 500. In some embodiments, the fan blades 140 may be integrated into a fan blade base component 130, and the base component 130 then rotates with the fan blades 140. In such an embodiment, the circumferentially outer edge of the fan blade base component 130 mat similarly terminate in a plurality of serrations 2340. Similarly, where the rotor contains additional components, such as a cap 800 as shown in FIGS. 7 and 8, and those additional components extend with the fan blades 140 to the circumferentially outer edge, such outer edge may be provided with serrations 2340 as well.

In some embodiments, at least some of the serrations 2340, such as those integrated into the fan blades 140, may be angled with respect to a mean flow line 2350 established by the fan blades. As such, the serrations 2340 may be swept back, as shown in FIG. 23B, such that they interfere with airflow generated by an adjacent fan blade 140.

Such serrations may reduce the perpendicular component of a turbulent boundary layer flow leaving a surface of the corresponding blade or component. Acoustic emissions typically scale with the fifth or sixth power with velocity, resulting in a large impact. Accordingly, the serrations allow for the reduction of this characteristic of the flow.

As discussed above, the axial intake 180 and the centrifugal outlet 170 are defined by rotor 110, or fan unit, components including the fan blades 140 of the fan assembly 100. The guide element 160, or shroud, then either comprise or are mounted on a stator 120, and the blades 140 are mounted on the rotor 110.

A motor 150 is then provided to rotate the rotor 110, or fan unit, relative to the stator 120. The motor 150 may be located adjacent the axial intake 180, and may be mounted axially on the unit.

In some embodiments, as discussed at length above, the guide element 160 may be substantially cylindrical, and extends along the axis 230 of the axial intake. The motor 150 may be located at least partially within the circumference of the guide element 160. In some such embodiments, as shown, the guide element 160 may then include a mounting structure 300 for the motor 150. The mounting structure 300 may then reduce a size of an internal chamber 310 within the guide element 160 adjacent the axial intake 180. As such, the mounting structure 300 may be, for example, substantially conical, as seen in the cross-section of FIG. 22, and may control the flow of airflow within the chamber 310.

Further, as can be seen in FIG. 11, the rotor 110 may be mounted on the motor itself 150, while the motor 150 is mounted on the mounting structure 300. Accordingly, the motor 150, in combination with the mounting structure 300, may at least partially define a gap 320 between the rotor 110 and the stator 120 of the fan assembly 100.

It is noted that in the embodiments shown, the fan blades 140 are arranged circumferentially at regular intervals. However, in some embodiments, the plurality of blades 140 may be located such that the spacing between adjacent blades 140 is varied. In this way, the blades 140 may be used to avoid certain noises.

Many of the structures described herein may be shaped and optimized for a slow speed airflow. For example, the channels 2300 described herein may be optimized for an average flow speed below around 5 m/s.

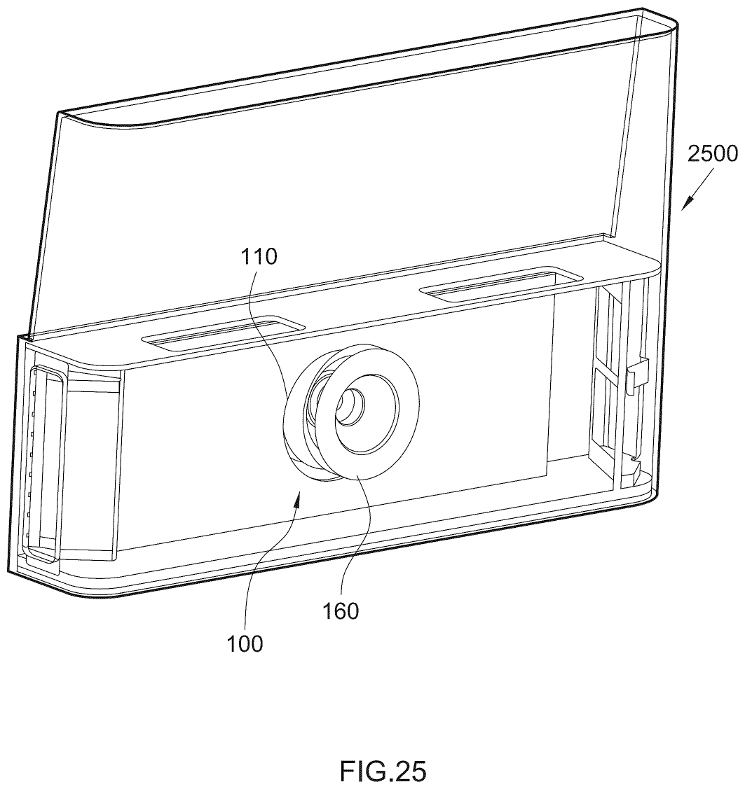

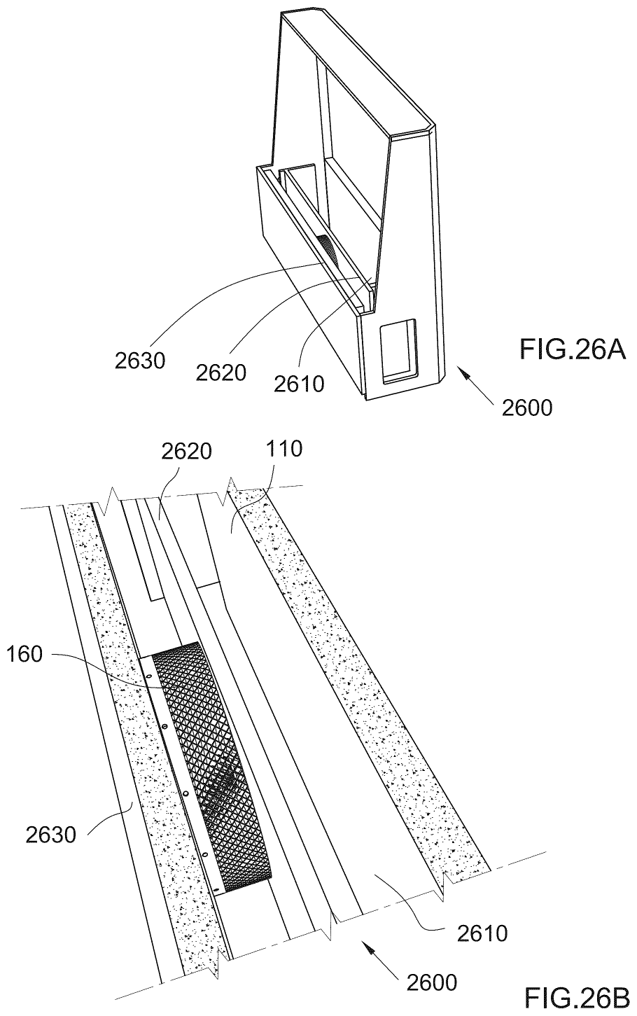

FIG. 25 is a housing 2500 for containing the fan assembly 100 of FIG. 1. FIGS. 26A-B are different views of a housing 2600 for containing the fan assembly of FIG. 1. As shown, the fan assembly 100 may then include or be integrated into the housing 2600.

In some embodiments, the housing 2600 includes an inner housing 2610 enclosing the fan unit 110. The guide element 160 may then extend through a wall 2620 of the inner housing 2610 to an outer housing 2630 comprising the airflow channel 190. In any event, various parts of the housing 2500, 2600 may be acoustically damped using insulation and/or circuitous airflow paths. In this way, both the inlet and the exhaust may be mounted in a dampening material and/or structure.

In some embodiments, the centrifugal outlet comprises at least one exhaust guide for converting rotational flow at the centrifugal outlet 170 into pressure.

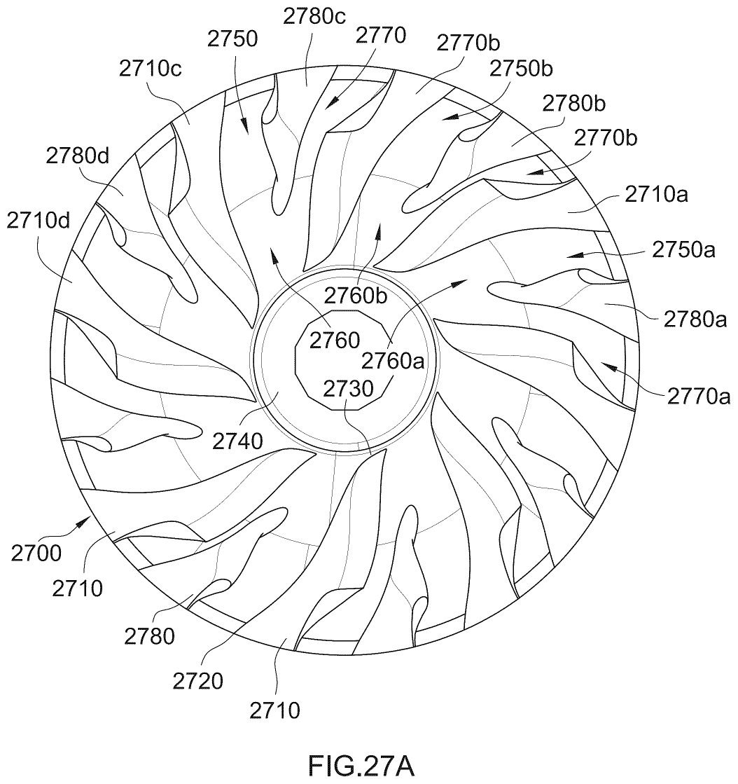

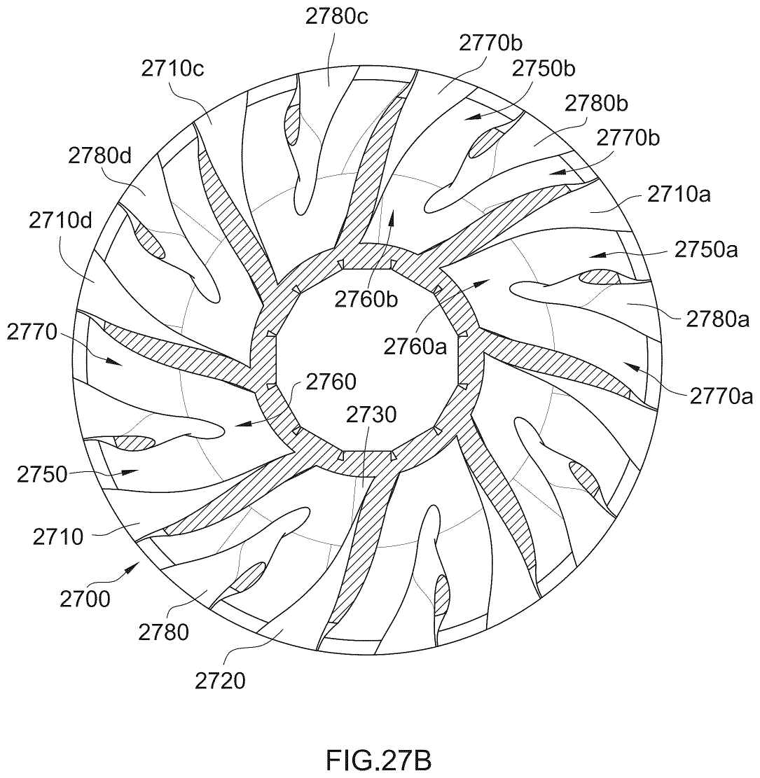

FIGS. 27A-B are front elevation views of an alternate embodiment 2700 of the part of the rotor 110 of FIG. 5. Specifically, the component shown 2700 corresponds to and replaces the base component 130 of the rotor 110 discussed above.

As shown, the base component 2700 contains a plurality of fan blades 2710. Each of the fan blades 2710 then extends from a radially outer end 2720 to a radially inner end 2730 adjacent a hub 2740 of the fan assembly 100. The hub 2740 of the fan assembly 100 may be integrated into the base component 2700.

During use, as noted above, the rotor 110 rotates relative to the stator 120, and as such, the fan blades 2710 sweep past any given point of the guide element 160. Any airflow passing through the guide element 160 is then swept up by the passing fan blades 2710, simultaneously moving the airflow in the direction of the axial intake 180 and generating suction for drawing additional airflow through the guide element.

The plurality of fan blades 2710 then combine to define airflow paths 2750 formed between adjacent fan blades. Such airflow paths 2750 then extend from the axial intake 180 to the centrifugal outlet 170 in the complete assembly discussed above.

In some embodiments, the airflow paths 2750 may comprise primary airflow paths 2760 and secondary airflow paths 2770. As shown in FIGS. 27A and 27B, primary airflow paths 2760 may be formed between adjacent fan blades 2710 extending from the axial intake 180 to the centrifugal outlet 170. The fan assembly 100 may then further include secondary splitter blades 2780 located within the airflow paths 2750. The secondary splitter blades 2780 may then further divide the corresponding primary airflow paths 2760 into secondary airflow paths 2770 as the primary airflow paths approach the substantially centrifugal outlet 170.

In some embodiments, such as that shown in FIGS. 27A and 27B, airflow paths may differ from each other in size or geometry. Accordingly, a first airflow path 2750a comprising a first primary airflow path 2760a and the secondary airflow paths 2770a contained therein may differ in size or geometry from a second airflow path 2750b comprising a second primary airflow path 2760b and the secondary airflow paths 2770b contained therein.

This may be, for example, by varying the spacing between adjacent fan blades 2710 or splitter blades 2780.

In some embodiments, each fan blade 2710 may be considered in combination with the adjacent splitter blade 2780, and the pairs may be shifted relative to a rotationally symmetric position. Accordingly, the embodiment discussed above with respect to FIG. 23A may have n-fold rotational symmetry, with n being 8 in the example. As such, rotating the embodiment of 23A about its axis by 45 degrees results in an identical geometry with respect to the blades.

In contrast, in the embodiment of FIGS. 27A and 27B, blades are offset from their rotationally symmetric locations. For example, in the embodiment shown, in a sequence of four pairs of blades 2710, 2780, a first 2710a, 2780a is shifted by 3 degrees about the circumference of the base component 2700, a second 2710b, 2780b is shifted by zero degrees, a third 2710c, 2780d is shifted by 1 degree, and a fourth 2710d, 2780d is shifted by 0 degrees.

The resulting spacing may improve the natural balance of the fan assembly 100 taken as a whole, resulting in less noise and less turbulence. In some cases, the resulting spacing reduces the perceived noise, or modifies the perceived acoustic energy so as to make it less obtrusive. For example, the configuration described may spread a tone across multiple distinct frequency peaks, thus reducing the perceived nose. For example, if blades pass with fixed spacing between the blades, the drumbeat sound of the blade impulses as the blades pass a given point are perceived as a steady metronomic sound. In the frequency domain, a single large tonal peak would then be observed. In contrast, in the embodiment described having uneven gap spacing, the drumbeat is no longer steady, and multiple lesser amplitude tones will appear in the spectrum. As such, the single peak is lower, and additional peaks appear next to the single peak, resulting in the same amount of acoustic energy presented across multiple tones and perceived as less annoying.

In the embodiment shown, the sequence of four sets of blades, 2710a, 2780a, 2710b, 2780b, 2710c, 2780c, 2710d, 2780d, is repeated, such that the base component 2700 still retains 2-foled rotational symmetry. However, alternative embodiments without such symmetry are contemplated as well.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A fan assembly comprising:
a substantially centrifugal outlet;
an axial intake;
an airflow channel extending substantially perpendicular to the axial intake; and
a guide element for redirecting airflow adjacent the axial intake;
wherein the axial intake is spaced apart from a back wall of the airflow channel by a first distance, and
wherein the guide element is positioned between the axial intake and the back wall of the airflow channel, or wherein the guide element comprises a back surface of the fan assembly, such that airflow from the airflow channel passes through the guide element to enter the axial intake.

2. The fan assembly of claim 1, wherein the guide element directs airflow towards the axial intake circumferentially relative to an axis of the axial intake in a direction of rotation of blades of the fan assembly.

3. The fan assembly of claim 2, wherein the guide element is a substantially cylindrical perforated shroud centered on the axis of the axial intake and comprising channels running substantially radially from the axial intake, and wherein the radially inner ends of the channels are angled or bend in the direction of rotation of the blades relative to the radial direction.

4. The fan assembly of claim 3, wherein the axial intake and the centrifugal outlet comprise a fan unit, the fan unit further comprising the blades of the fan assembly, and wherein at least some of the channels are sloped towards the fan unit at the radially inner ends of the channels.

5. The fan assembly of claim 3 wherein the axial intake and the centrifugal outlet comprise a fan unit, the fan unit further comprising the blades of the fan assembly, and wherein a first plurality of channels of the shroud are located at a first axial location along a thickness of the cylindrical shroud and a second plurality of channels of the shroud are located at a second axial location along the thickness of the cylindrical shroud closer to the fan unit than the first axial location, and wherein the second plurality of channels deviate from the radial direction by more than the first plurality of channels.

6. The fan assembly of claim 3, wherein each of the channels is smaller at the radially inner end than at a corresponding radially outer end.

7. The fan assembly of claim 3, wherein each of the channels are substantially diamond shaped.

8. The fan assembly of claim 3, wherein each of the channels has a length to width ratio greater than approximately 3.

9. The fan assembly of claim 2, wherein the fan assembly comprises a plurality of fan blades, and wherein each fan blade extends from a radially outer end adjacent the guide element to a radially inner end adjacent a hub and is sloped relative to the axial direction of the axial intake.

10. The fan assembly of claim 9, wherein, for each fan blade, a slope at the radially outer end is steeper than a slope at the radially inner end.

11. The fan assembly of claim 9, wherein airflow paths are formed between adjacent fan blades extending from the axial intake to the centrifugal outlet, and wherein each fan blade has a width that increases as it extends away from the axial intake, such that the airflow paths are narrowed following the axial intake.

12. The fan assembly of claim 11, wherein each fan blade has an airfoil-like cross-section.

13. The fan assembly of claim 9, wherein primary airflow paths are formed between adjacent fan blades extending from the axial intake to the centrifugal outlet, and further comprising at least one secondary splitter blade located within each of the primary airflow paths, and wherein the secondary splitter blade further divides the corresponding primary airflow path into secondary airflow paths as the primary airflow path approaches the substantially centrifugal outlet.

14. The fan assembly of claim 13, wherein each of the fan blades and the secondary splitter blades have an airfoil-like cross-section.

15. The fan assembly of claim 13, wherein the secondary airflow paths are smaller than the primary airflow paths, and wherein, during use, turbulent eddies are damped sequentially, thereby reducing leading edge blade impingement.

16. The fan assembly of claim 13, wherein a plurality of primary airflow paths are formed between adjacent fan blades extending from the axial intake to the centrifugal outlet, and each primary airflow path divides into a plurality of secondary airflow paths, and wherein a first primary airflow path of the plurality of primary airflow paths and the plurality of secondary airflow paths contained therein differs from a second primary airflow path of the plurality of primary airflow paths and the plurality of secondary airflow paths contained therein in size or geometry.

17. The fan assembly of claim 9, wherein each fan blade twists from the corresponding radially inner end to the corresponding radially outer end, and wherein each fan blade terminates in a reverse twist, such that a radially outermost cross-section of the fan blade is steeper than at least one radial cross-section of the fan blade between the radially outer end and the radially inner end.

18. The fan assembly of claim 9, wherein each fan blade terminates in a plurality of serrations along a circumferentially outer end.

19. The fan assembly of claim 18, wherein the serrations are angled with respect to a mean flow line established by the fan blades.

20. The fan assembly of claim 9, wherein a plurality of airflow paths are formed between adjacent fan blades extending from the axial intake to the centrifugal outlet, and wherein a first airflow path of the plurality of airflow paths between a first pair of adjacent fan blades differs from a second airflow path of the plurality of airflow paths between a second pair of adjacent fan blades in size or geometry.

21. The fan assembly of claim 1, wherein the axial intake and the centrifugal outlet comprise a fan unit, the fan unit further comprising a plurality of blades of the fan assembly, and wherein the guide element is mounted on a stator and wherein the plurality of blades are mounted on a rotor for the fan unit.

22. The fan assembly of claim 21 further comprising a motor located adjacent the axial intake.

23. The fan assembly of claim 22, wherein the guide element is substantially cylindrical and extends along an axis of the axial intake, and wherein the motor is located at least partially within the circumference of the guide element.

24. The fan assembly of claim 23, wherein the guide element comprises a mounting structure for the motor, and wherein the mounting structure reduces a size of an internal chamber within the guide element adjacent the axial intake.

25. The fan assembly of claim 23, wherein the motor at least partially defines a gap between the rotor and stator of the fan assembly.

26. The fan assembly of claim 25, wherein the fan assembly is supported by the motor or the stator.

27. The fan assembly of claim 1 wherein the axial intake and the centrifugal outlet comprise a fan unit, the fan unit further comprising a plurality of blades of the fan assembly, wherein the plurality of blades are located circumferentially about the axial intake, and wherein spacing between adjacent blades of the plurality of blades is varied.

28. The fan assembly of claim 1 wherein the axial intake and the centrifugal outlet comprise a fan unit, the fan unit further comprising a plurality of blades of the fan assembly, wherein the fan assembly further comprises an inner housing enclosing the fan unit, and wherein the guide element extends through a wall of the inner housing to an outer housing comprising the airflow channel.

29. The fan assembly of claim 1, wherein the centrifugal outlet comprises at least one exhaust guide for converting rotational flow at the centrifugal outlet into pressure.
